(19) United States
(12) Patent Application Publication
(10) Pub. No.: US 2024/0287638 A1
(43) Pub. Date: Aug. 29, 2024

(54) METHOD FOR MANUFACTURING OF A STEEL PART

(71) Applicant: ArcelorMittal, Luxembourg (LU)

(72) Inventors: Pierrick FORT, Saint Hubert (FR); Aude NADLER, Metz (FR); Kangying ZHU, Metz (FR); Astrid PERLADE, Le Ban-Saint-Martin (FR); Michel SOLER, Ars Laquenexy (FR); Frédéric KEGEL, Yutz (FR)

(21) Appl. No.: 18/573,247

(22) PCT Filed: Jul. 16, 2021
(86) PCT No.: PCT/IB2021/056448

§ 371 Date: Dec. 21, 2023

(51) Int. Cl. C21D 9/46; C21D 8/02; C22C 38/00; C22C 38/02; C22C 38/04; C22C 38/06

(52) U.S. Cl. CPC C21D 9/46; C21D 8/0226; C21D 8/0236; C21D 8/0273; C22C 38/001; C22C 38/002; C22C 38/02; C22C 38/04; C22C 38/06; C21D 2211/001; C21D 2211/002; C21D 2211/005; C21D 2211/008; C21D 2261/00

(57) ABSTRACT

A process for manufacturing a steel part, including the following successive steps: providing a steel sheet having a composition including by weight percent: C: 0.05—0.25%, Mn: 3.5-8%, Si 0.1-2%, Al: 0.01-3%, S≤0.010%, P≤0.020%, N≤0.008%, the remainder of the composition being iron and unavoidable impurities resulting from the smelting, and having a microstructure, in surface fraction, between 10% and 50% of retained austenite, 50% or more of the sum of ferrite, bainite and tempered martensite, less than 5% of fresh martensite, less than 2% of carbides and a carbon [C]A content in austenite, strictly more than 0.4% and strictly less than 0.7%, cutting the steel sheet to a predetermined shape, to obtain a steel blank, heating the steel blank to a temperature T_{warm} from (Md30-150° C.) to (Md30-50° C.), punching or shearing and forming the heat-treated steel blank at the T_{warm} temperature to obtain a steel part.

The present invention relates to a method to manufacture a steel part from steel sheet having a high hole expansion ratio during warm workability.

### BACKGROUND

To manufacture various items such as parts of body structural members and body panels for automotive vehicles, it is known to use sheets made of DP (Dual Phase) steels or TRIP (Transformation Induced Plasticity) steels.

### SUMMARY OF THE INVENTION

The strength of the cut-edge of TRIP steels is highly dependent on the stability of the residual austenite. Indeed, the unstable austenite can be destabilized into martensite when the part is cut, thus becoming a potential site of initiation of damage. To limit this effect, new high strength steels and method are continuously developed by the steelmaking industry, to obtain steel part with improved yield and tensile strengths, good ductility and formability, and more specifically a good stretch flangeability.

The publication WO2017131052 discloses a warm-workable high-strength steel sheet having superior warm workability and residual ductility after warm working. The elongation of this annealed steel sheet at a temperature of 150° C. is higher than 27%. To achieve such property, the carbon content in austenite has to be controlled under 0.4 wt. %, which is a particular constraint. Indeed, to ensure this low carbon level in retained austenite, the cooling of the annealed steel sheet has to be controlled and performed in two steps: one cooling up to 500° C. at an average cooling rate of 50° C./s, with a holding step at this temperature for example galvanizing and one cooling step from Ms to room temperature at an average rate of cooling not less than 10° C./s. Moreover, no information is given regarding the stretch flangeability which is a key feature for the manufacture of steel parts.

The purpose of the invention therefore is to solve the above-mentioned problem and to provide a method easily processable on conventional process routes to obtain a steel part from a steel having a high hole expansion ratio above or equal to 25% during warm workability

It is an object of the present invention to provide a process for manufacturing a steel part, comprising the following successive steps:
providing a steel sheet having a composition comprising by weight percent:
   C: 0.05-0.25%
   Mn: 3.5-8%
   Si: 0.1-2%
   Al: 0.01-3%
   S≤0.010%
   P≤0.020%
   N≤0.008%
and comprising optionally one or more of the following elements, in weight percentage:
   Cr: 0-0.5%
   Mo: 0-0.25%
the remainder of the composition being iron and unavoidable impurities resulting from the smelting, and having a microstructure comprising, in surface fraction,
   from 10% to 50% of retained austenite,
   50% or more of the sum of ferrite, bainite and tempered martensite,
   less than 5% of fresh martensite
   less than 2% of carbides
   a carbon [C]A content in austenite, strictly more than 0.4% in
weight and strictly less than 0.7% in weight, the weight percent of nitrogen % N, silicon % Si, manganese % Mn, chromium % Cr, nickel % Ni, copper % Cu, molybdenum % Mo, and carbon in austenite [C]_{A}, being such that Md30 is comprised from 200° C. to 350° C., Md30 being defined as

$$Md 30 ( ° C . ) = 551 - 46 {2}^{⋆} ( {[ C ]}_{A} + \% N ) - {9.2}^{*} \% Si - {8.1}^{*} \% Mn - {13.7}^{*} \% Cr - {29}^{*} ( \% Ni + \% Cu ) - {18.5}^{*} ( \% Mo )$$

cutting said steel sheet to a predetermined shape, so as to obtain a steel blank,
heating the steel blank to a temperature T_{warm} comprised from (Md30-150° C.) to (Md30-50° C.) to obtain a heat-treated steel blank,
punching or shearing the heat-treated steel blank at the said T_{warm} temperature,
forming the heat-treated steel blank at the said T_{warm} temperature to obtain a steel part

### DETAILED DESCRIPTION

Hereinafter, the term “warm cutting” refers to the part of the process where the steel blank is heated before to be punched or sheared.

Hereinafter, the term “room temperature” refers to a temperature of 20° C.

The composition of the steel according to the invention will now be described, the content being expressed in weight percent.

Hereinafter, Ae1 designates the equilibrium transformation temperature below which austenite is completely unstable, Ae3 designates the equilibrium transformation temperature above which austenite is completely stable, and Ms designates the martensite start temperature, i.e. the temperature at which the austenite begins to transform into martensite upon cooling. These temperatures can be calculated from a formula based on the weight percent of the corresponding elements:

$$\begin{matrix}Ae 1 = 670 + {15}^{*} \% Si - {13}^{*} \% Mn + {18}^{*} \% Al \\ Ae 3 = 890 - {20}^{*} √ \% C + {20}^{*} \% Si - {30}^{*} \% Mn + {130}^{*} \% Al \\ Ms = 560 - ( {30}^{*} \% Mn + {13}^{*} \% Si - {15}^{*} \% Al + {12}^{*} \% Mo ) - {600}^{*} ( 1 - exp ( - 0 , {96}^{*} \% C ) )\end{matrix}$$

According to the invention the carbon content is comprised from 0.05% to 0.25%. Above 0.25% of carbon, the amount of carbon in austenite is higher than the targeted value, annihilating the positive effect of warm cutting. Moreover, the weldability of the steel sheet may be reduced. If the carbon content is lower than 0.05%, the retained austenite fraction is not stabilized enough to obtain a sufficient elongation at room temperature. In a preferred embodiment of the invention, the carbon content is comprised from 0.05% to 0.2%. More preferably, the carbon content is comprised from 0.1% to 0.2%.

The manganese content is comprised from 3.5% to 8% to obtain sufficient elongation with the stabilization of the austenite. Above 8% of addition, the risk of central segregation increases to the detriment of ductility of the steel sheet and steel part. Below 3.5%, the final structure comprises an insufficient retained austenite fraction, so that the desired ductility is not achieved. Preferably, the manganese content is comprised from 3.5% to 7%. More preferably, the manganese content is comprised from 3.5% to 5%.

According to the invention, the silicon content is comprised from 0.1% to 2% to stabilize a sufficient amount of retained austenite. Above 2%, silicon oxides form at the surface, which impairs the coatability of the steel. In a preferred embodiment of the invention, the silicon content is comprised from 0.3% to 1.5%.

According to the invention the aluminium content is comprised from 0.01% to 3%, as aluminium is a very effective element for deoxidizing the steel in the liquid phase during elaboration and increasing the annealing process window. The aluminium content can be added up to 3% maximum, to avoid the occurrence of inclusions and to avoid oxidation problems.

Optionally some elements can be added to the composition of the steel according to the invention.

Chromium can optionally be added up to 0.5%. Above 0.5%, a saturation effect is noted, and adding chromium is both useless and expensive.

Molybdenum can optionally be added up to 0.25% in order to increase toughness. Above 0.25%, the addition of molybdenum is costly and ineffective in view of the properties which are required.

The remainder of the composition of the steel is iron and impurities resulting from the smelting. In this respect, P, S and N at least are considered as residual elements which are unavoidable impurities. Their content below or equal to 0.010% for S, below or equal to 0.020% for P and below or equal to 0.008% for N.

The microstructure of steel sheet according to the invention will now be described. The steel sheet has a microstructure consisting of, in surface fraction, from 10% to 50% of retained austenite, 50% or more of the sum of ferrite, bainite and tempered martensite, less than 5% of fresh martensite, less than 2% of carbides, a carbon [C]_{A} content in austenite strictly more than 0.4% and strictly less than 0.7%, and with the weight percent of nitrogen % N, silicon % Si, manganese % Mn, chromium % Cr, nickel % Ni, copper % Cu, molybdenum % Mo and carbon in austenite [C]_{A}, are such that Md30 is comprised from 200° C. to 350° C., Md30 being defined as

$$Md 30 ( ° C . ) = 551 - 46 {2}^{⋆} ( {[ C ]}_{A} + \% N ) - {9.2}^{*} \% Si - {8.1}^{*} \% Mn - {13.7}^{*} \% Cr - {29}^{*} ( \% Ni + \% Cu ) - {18.5}^{*} ( \% Mo )$$

The microstructure of steel sheet comprises from 10% to 50% of retained austenite, to ensure high ductility of the steel at room temperature.

The carbon content in austenite is strictly higher than 0.4% to guarantee stability of austenite, elongation higher than 10% at room temperature and to ensure that the steel part can reach the targeted hole expansion ratio. Above 0.7%, the austenite is too much stabilized and the warm cutting of the steel blank has no effect on hole expansion ratio. This carbon content is measured before warm cutting, with XRD diffraction.

The microstructure of the steel sheet comprises 50% or more of the sum of ferrite, bainite and tempered martensite. The ferrite is formed during the soaking of the steel sheet.

In the preferred embodiment of the invention wherein the provided steel sheet is a cold rolled steel sheet undergoing a cooling and partitioning process, the tempered martensite is formed during the partitioning of the cold rolled steel sheet. In the preferred embodiment of the invention wherein the provided steel sheet is a hot rolled steel sheet, the tempered martensite is self tempered martensite, which is formed during the cooling above Ms of the hot rolled steel sheet.

If the sum of ferrite, bainite and tempered martensite fraction is lower than 50%, the elongation does not reach 10% at room temperature.

The microstructure of the steel sheet comprises less than 5% of fresh martensite. Above 5%, fresh martensite reduces the toughness of the steel sheet.

Fresh martensite is formed during the cooling to room temperature of the steel sheet.

Moreover, the microstructure of the steel sheet of the invention comprises less than 2% of carbides.

The weight percent of nitrogen % N, silicon % Si, manganese % Mn, chromium % Cr, nickel % Ni, copper % Cu, molybdenum % Mo and carbon in austenite [C]_{A}, are such that Md30 is comprised from 200° C. to 350° C. This Md30 temperature corresponds to the temperature from which 50% of retained austenite is transformed into martensite after a deformation of 30%.

The steel part according to the invention can be produced by any appropriate manufacturing method and the man skilled in the art can define one. It is however preferred to use the method according to the invention comprising the following steps:

A steel sheet having aforementioned composition and microstructure is provided and cut to a predetermined shape, so as to obtain a steel blank.

The steel blank is then heated to a temperature T_{warm} comprised from (Md30−150° C.) to (Md30-50° C.) to obtain a heat-treated steel blank, and punch or shear at the said T_{warm} temperature, before being formed at the said T_{warm} temperature to obtain a steel part. Above (Md30-50° C.), the austenite is too stable to obtain an improvement in hole expansion ratio. Below (Md30-150) austenite is destabilized in martensite and becomes a potential site of initiation of damage, leading to a low hole expansion ratio.

In a preferred embodiment of the invention, the steel sheet provided to manufacture the steel part is produced by the following successive step:

A steel slab having a composition described above is hot rolled to obtain a hot rolled steel sheet. The hot rolled steel sheet is then coiled to a temperature T_{coil} comprised from 200° C. to 700° C. After the coiling, the sheet can be pickled to remove oxidation.

The hot rolled steel sheet is then annealed to an annealing temperature T_{HBA} comprised from 500° C. to 680° C. to obtain a hot rolled and annealed steel sheet. This annealing leads to steel softening and stability of austenite after final annealing thanks to carbon and manganese concentration in carbides or austenite.

The hot rolled and annealed steel sheet is then cold rolled to obtain a cold rolled steel sheet. The cold-rolling reduction ratio is preferably comprised between 20% and 80%. Below 20%, the recrystallization during subsequent heat-treatment is not favored, which may impair the ductility of the steel sheet. Above 80%, there is a risk of edge cracking during cold rolling.

The cold rolled steel sheet is then heated to a temperature Tₛₒₐₖ above or equal to 680° C. and below a temperature T₁, T₁ being a temperature above which more than 5% martensite is formed after cooling, and maintained at said soaking temperature Tₛₒₐₖ for a soaking time tₛₒₐₖ less than 500s, in order to keep fine retained austenite grain size and consequently, high strength and ductility.

The heat-treated steel sheet is then cooled to room temperature, in order to obtain a steel sheet with microstructure described above.

In an other preferred embodiment of the invention, the steel sheet provided to manufacture the steel part is produced by the following successive step:

A steel slab having a composition described above is hot rolled to obtain a hot rolled steel sheet. The hot rolled steel sheet is then coiled to a temperature T_{coil} comprised from 200° C. to 700° C. After the coiling, the sheet can be pickled to remove oxidation.

The hot rolled steel sheet is then annealed to an annealing temperature T_{HBA} comprised from 500° C. to 680° C. to obtain a hot rolled and annealed steel sheet. This annealing leads to steel softening and help to stabilize austenite during final annealing thanks to high carbon and manganese concentration in carbides or austenite.

The hot rolled and annealed steel sheet is then cold rolled to obtain a cold rolled steel sheet. The cold-rolling reduction ratio is preferably comprised between 20% and 80%. Below 20%, the recrystallization during subsequent heat-treatment is not favored, which may impair the ductility of the steel sheet. Above 80%, there is a risk of edge cracking during cold rolling.

The cold rolled steel sheet is then heated to a temperature Tₛₒₐₖ above or equal to 780° C. and maintained at said soaking temperature Tₛₒₐₖ for a soaking time tₛₒₐₖ less than 500s, in order to keep fine retained austenite grain size and consequently, high ductility.

The heat-treated steel sheet is then cooled to a temperature T_{Q} comprised from 20° C. to (Ms−50° C.) and heated to a partitioning temperature T_{P} comprised from 150° C. to 550° C., and maintained at said partitioning temperature T_{P} for a partitioning time t_{P} comprised from 1 s to 1800s. The heat-treated steel sheet is then cooled to room temperature, in order to obtain a steel sheet with microstructure described above.

In an other preferred embodiment, the steel sheet provided to manufacture the steel part is produced by the following successive step:

A steel slab having a composition described above is hot rolled to obtain a hot rolled steel sheet. The hot rolled steel sheet is then coiled to a temperature T_{coil} comprised from 200° C. to 700° C., before to be cooled to room temperature.

According to the invention, the hole expansion ratio of the heat-treated steel HER_{Twarm} heated to T_{warm}, and the hole expansion ratio of the steel at 20° C. HER_{20 ° C.}, are such that (HER_{Twarm}-HER_{20 ° C.})/HER_{20 ° C.} is above or equal to 50%.

Preferably, the hole expansion ratio of the heat-treated steel HER_{150 ° C.} heated to T_{warm} of 150° C., and the hole expansion ratio of the steel at 20° C. HER_{20 ° C.}, are such that (HER_{150 ° C.}-HER_{20 ° C.})/HER_{20 ° C.} is above or equal to 50%.

HER are measured according to ISO 16630.

According to the invention, the steel has elongation El at room temperature above or equal to 10%. El is measured according to ISO standard ISO 6892-1.

In a preferred embodiment of the invention, the steel has HER_{20 ° C.} above or equal to 10%. In an other preferred embodiment of the invention, the heat-treated steel has HER_{150 ° C.} above or equal to 25%.

### EXAMPLES

3 grades, whose compositions are gathered in table 1, were cast in semi-products and processed into steel sheets.

### Table 1—Compositions

The tested compositions are gathered in the following table wherein the element contents are expressed in weight percent.

| | | | | | | | | | | Ae1 | Ae3 | Ms |
|---|---|---|---|---|---|---|---|---|---|---|---|---|
| Steel | C | Mn | Si | Al | Cr | Mo | S | P | N | (° C.) | (° C.) | (° C.) |
| A | 0.11 | 4.78 | 0.46 | 1.58 | 0 | 0 | 0.001 | 0.014 | 0.003 | 653 | 955 | 374 |
| B | 0.18 | 3.8 | 1.2 | 0.3 | 0 | 0.2 | 0.0008 | 0.011 | 0.003 | 652 | 831 | 337 |
| C | 0.37 | 1.93 | 1.95 | 0.041 | 0.33 | 0.098 | 0.0019 | 0.01 | 0.0029 | 679 | 864 | 297 |

Steels A and B are according to the invention, steel C is out of the invention

### Table 2—Process Parameters of the Steel Sheets

Steel semi-products, as cast, were reheated at 1200° C., hot rolled and then coiled at 450° C. The hot rolled steel sheets are then heated to a temperature T_{HBA} comprised from 500° C. to 680° C. and maintained at said temperature for a holding time t_{HBA}. The hot rolled and heat-treated steel sheet are then cold rolled with a reduction rate of 50%, before to be heated to a soaking temperature Tₛₒₐₖ and maintained at said temperature for a holding time tₛₒₐₖ. In trials 3 and 4, the heat-treated steel sheets are quenched under Ms-50° C., before to be heated to a partitioning temperature T and maintained at said T temperature for a holding time t_{P}.

The steel sheets are then cooled to room temperature. The following specific conditions to obtain the heat-treated steel sheets were applied:

| | | Hot band | | Soaking | | Quenching | Partitioning | |
|---|---|---|---|---|---|---|---|---|
| | | annealing (HBA) | | Tₛₒₐₖ | tₛₒₐₖ | temperature | T_{P} | t_{P} |
| Trials | Steel | T_{HBA}(° C.) | t_{HBA}(h) | (° C.) | (s) | (° C.) | (° C.) | (s) |
| 1 | A | 600 | 15 | 737 | 210 | — | — | — |
| 2 | A | 600 | 15 | 725 | 213 | — | — | — |
| 3 | B | 620 | 15 | 830 | 170 | 175 | 450 | 90 |
| 4 | C | 650 | 8 | 870 | 120 | 230 | 410 | 280 |
| 5 | A | 600 | 15 | 770 | 200 | — | — | — |

Underlined values: parameters which do not allow to obtain the targeted properties

The steel sheets were analyzed, and the corresponding microstructure are gathered in table 3.

### Table 3—Microstructure of the Steel Sheet

The microstructure of the steel sheet was determined:

| | | Ferrite + | | | | |
|---|---|---|---|---|---|---|
| | Retained | Tempered | Fresh | | | |
| | austenite | martensite + | martensite | Carbides | [C]_{A} | Md30 |
| Trials | (%) | bainite (%) | (%) | (%) | (wt %) | (° C.) |
| 1 | 25.5 | 72.5 | 2 | 0 | 0.43 | 285 |
| 2 | 23 | 76 | 0 | 1 | 0.47 | 256 |
| 3 | 14 | 85 | 0 | 1 | 0.60 | 225 |
| 4 | 17.9 | 80.6 | 1 | 0.50 | 0.89 | 99 |
| 5 | 11 | 60 | 29 | 0 | 0.29 | 352 |

Underlined values: out of the invention

[C]_{A} corresponds to the amount of carbon in austenite, in weight percent. It is measured with X-rays diffraction.

The surface fractions of phases in the microstructure are determined through the following method: a specimen is cut from the steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the volume fraction of retained austenite is performed thanks to X-ray diffraction.

The determination of the type of martensite can be done and quantified thanks to a Scanning Electron Microscope.

The percentage of carbides is determined thanks to a section of sheet examined through Scanning Electron Microscope with a Field Emission Gun (“FEG-SEM”) and image analysis at a magnification greater than 15000×.

The steel sheets were then cut to obtain a steel blank. The steel blanks were analyzed at room temperature (20° C.) and the corresponding mechanical properties are gathered in table 4.

The steel blanks were then reheated to a temperature T_{warm} of 150° C. before to be punched or sheared at said T_{warm} temperature.

The heat-treated steel blanks were analyzed, and the corresponding mechanical properties are gathered in table 4.

TABLE 4
Mechanical properties of the steel blanks

| | (HER_{Twarm} − | | | |
|---|---|---|---|---|
| | HER_{20° C.})/ | Properties at room | | Properties at |
| | HER_{20° C.} at | temperature (20° C.) | | T_{warm} = 150° C. |
| Trials | T_{warm} = 150° C. | EI (%) | HER_{20° C.} (%) | HER_{150° C.} (%) |
| 1 | 77% | 14.6 | 15.8 | 28.02 |
| 2 | 84% | 19 | 22.9 | 42.1 |
| 3 | 58% | 13.3 | 26.7 | 42.1 |
| 4 | 3% | 18.4 | 22.1 | 22.8 |
| 5 | nd | 9.1 | 11 | nd |

Underlined values: out of the invention
nd: non determined value

In the trials 1-3 compositions and manufacturing conditions correspond to the invention. Thus, the desired properties are obtained. The effect of the warm cutting of the steel blank is in particular highlighted by the increase of hole expansion ratio HER_{150 ° C.} at 150° C. in comparison to HER_{20 ° C.} the hole expansion ratio at room temperature.

In trial 4, the carbon content of the steel sheet is too high, leading to a high carbon content in austenite. This implies that austenite is stabilized, annihilating effect of warm cutting on hole expansion ratio.

In trial 5, the steel is annealed at a higher temperature compared to trials 1 and 2. High amount of austenite is thus formed with a low carbon content inside, and so less stable than in trials 1 and 2. This austenite is thus transformed in fresh martensite during the cooling and warm cutting. This amount of fresh martensite leads to an elongation of the steel part at room temperature lower than 10%.

1-9. (canceled)

10: A process for manufacturing a steel part, the process comprising the following successive steps:
providing a steel sheet having a composition comprising by weight percent:
C: 0.05-0.25%
Mn: 3.5-8%
Si: 0.1-2%
Al: 0.01-3%
S≤5 0.010%
P≤0.020%
N≤0.008%
and comprising optionally one or more of the following elements, in weight percentage:
Cr: 0-0.5%
Mo: 0-0.25%
a remainder of the composition being iron and unavoidable impurities resulting from processing, and having a microstructure comprising, in surface fraction,
from 10% to 50% of retained austenite,
50% or more of the sum of ferrite, bainite and tempered martensite,
less than 5% of fresh martensite
less than 2% of carbides
a carbon [C]_{A} content in austenite, strictly more than 0.4% in weight and strictly less than 0.7% in weight,
the weight percent of nitrogen % N, silicon % Si, manganese % Mn, chromium % Cr, nickel % Ni, copper % Cu, molybdenum % Mo, and carbon in austenite [C]_{A}, being such that Md30 is comprised from 200° C. to 350° C., Md30 being defined as
Md30(° C.)=551−462*([C]_{A}+%N)−9.2*%Si−8.1*%Mn−13.7*%Cr−29 *(%Ni+%Cu)−18.5*(%Mo);
cutting the steel sheet to a predetermined shape, so as to obtain a steel blank;
heating the steel blank to a temperature T_{warm} from (Md30-150° C.) to (Md30-50° C.) to obtain a heat-treated steel blank;
punching or shearing the heat-treated steel blank at the T_{warm} temperature; and
forming the heat-treated steel blank at the T_{warm} temperature to obtain the steel part.

11: The process as recited in claim 10 wherein the steel sheet is provided by the following successive steps:
hot rolling of a steel slab having the composition;
coiling the hot rolled steel sheet at a coiling temperature T_{coil} from 200° C. to 700° C.;
annealing the hot rolled steel sheet to an annealing temperature T_{HBA} from 500 to 680° C. to obtain a hot rolled and annealed steel sheet;
cold rolling the hot rolled and annealed steel sheet to obtain a cold rolled steel sheet;
heating the cold rolled steel sheet to a temperature Tₛₒₐₖ above or equal to 680° C. and below a temperature T₁, T₁ being a temperature above which more than 5% martensite is formed after cooling and maintaining the cold rolled steel sheet at said soaking temperature Tₛₒₐₖ for a soaking time tₛₒₐₖ less than 500s, to obtain a heat-treated steel sheet; and
cooling the heat-treated steel sheet to room temperature.

12: The process as recited in claim 10 wherein the steel sheet is provided by the following successive steps:
hot rolling a steel slab having the composition to obtain a hot rolled steel sheet;
coiling the hot rolled steel sheet at a coiling temperature T_{coil} comprised between 200° C. and 700° C.;
annealing the hot rolled steel sheet to an annealing temperature T_{HBA} comprised from 500 to 680° C. to obtain a hot rolled and annealed steel sheet;
cold rolling the hot rolled and annealed steel sheet to obtain a cold rolled steel sheet;
heating the cold rolled steel sheet to a temperature Tₛₒₐₖ above or equal to 780° C. and maintaining the cold rolled steel sheet at said soaking temperature Tₛₒₐₖ for a soaking time tₛₒₐₖ less than 500s, to obtain a heat-treated steel sheet;
cooling the heat-treated steel sheet to a temperature T_{Q} comprised from 20° C. and (Ms−50° C.), and heating the heat-treated steel sheet to a partitioning temperature T_{P} comprised from 150° C. to 550° C., and maintaining the steel sheet at said partitioning temperature T_{P} for a partitioning time tₚ comprised from 1 s to 1800 s; and
cooling the heat-treated steel sheet to room temperature.

13: The process as recited in claim 10 wherein the steel sheet is provided by the following successive steps:
hot rolling a steel slab having a composition according to claim 1 to obtain a hot rolled steel sheet;
coiling the hot rolled steel sheet at a coiling temperature T_{coil} from 200° C. to 700° C.; and
cooling the hot rolled steel sheet to room temperature.

14: The process as recited in claim 10 wherein the T_{warm} temperature is from 50° C. to 250° C.

15: The process as recited in claim 10 wherein a hole expansion ratio of the heat-treated steel HER_{Twarm} at T_{warm}, and a hole expansion ratio of the steel at 20° C. HER_{20° C.}, are such that
$$( {HER}_{Twarm} - {HER}_{20 ° C .} ) / {HER}_{20 ° C} \geq 50 \% .$$

16: The process as recited in claim 10 wherein an elongation El of the steel at 20° C. is above or equal to 10%.

17: The process as recited in claim 10 wherein HER_{20° C.}, of the steel is above or equal to 10%.

18: The process as recited in claim 10 wherein HER_{150° C.} of the heat-treated steel is above or equal to 25%.
